(19) United States
(12) Patent Application Publication
(10) Pub. No.: US 2020/0160791 A1
(43) Pub. Date: May 21, 2020

(54) INFORMATION DISPLAY APPARATUS

(71) Applicant: CJK associates co., ltd, Seoul (KR)

(72) Inventor: Chul CHUNG, Seoul (KR)

(73) Assignee: CJK associates co., ltd, Seoul (KR)

(21) Appl. No.: 16/373,667

(22) Filed: Apr. 3, 2019

(30) Foreign Application Priority Data
Nov. 21, 2018 (KR) 10-2018-0144256

(51) Int. Cl. G09G 3/3275; G09G 3/20

(52) U.S. Cl. CPC G09G 3/3275; G09G 3/2003; G09G 2320/0666; G09G 2360/147; G09G 2340/0407; G09G 2320/045; G09G 2320/0233; G09G 2320/0626

(57) ABSTRACT

A technique for an information display apparatus technique with improved display characteristics is disclosed. An image, which is displayed at a low resolution by light emitting diodes in a light emitting display panel, is modulated by light modulating devices arranged at a higher resolution than the light emitting diodes in a light modulating panel, which overlaps a front surface of the light emitting display panel, so that a display of a high resolution image is achieved. Adjustment of non-uniformity of characteristics of the light emitting diodes may be achieved by adjusting the light emission of the light emitting diodes on one hand and may be further achieved by adjusting modulation parameters of the light modulating devices additionally. A light emitting display panel may further include a plurality of light detecting devices each of which is adjacently arranged to a corresponding light emitting diode. A degree of degradation during use of the light emitting diodes is measured by the light detecting device and the degradation during use of the light emitting diodes is compensated for based thereon.

### CROSS-REFERENCE TO RELATED APPLICATION(S)

This application claims priority from Korean Patent Application No. 10-2018-0144256, filed on Nov. 21, 2018, in the Korean Intellectual Property Office, the disclosure of which is incorporated herein by reference in its entirety.

### BACKGROUND

### 1. Field

The following description relates to a technique for an information display apparatus with improved display characteristics.

### 2. Description of Related Art

In the field of flat panel displays, light emitting diodes (LEDs) are being widely used. The LEDs may be used as back lights of a light modulating panel, and the LEDs themselves may constitute an LED display. Recently, the number of LEDs is being increased even when the LEDs are used as back lights, and a local dimming technique for improving contrast is also being used. In order to adjust local dimming, it is necessary to individually drive LEDs.

With a technique for an information display apparatus using a thin film transistor (TFT) being developed, high-resolution liquid crystal display (LCD) displays are also becoming popular. Since an LCD display displays an image by shuttering a back light, light efficiency is lowered and a contrast characteristic is limited. On the other hand, an LED display composed of LEDs themselves has high light efficiency or contrast characteristics. However, the price of the LED display is still high enough to be unsuitable for general consumer electronics as a resolution of the LED display is increased.

Meanwhile, in LEDs which are widely used as light emitting devices, it is difficult to achieve uniformity of light emission characteristics for each device in a manufacturing process thereof. From the viewpoint of display quality, it is difficult to achieve uniformity of light emission characteristics of LEDs both when the LEDs are used as back lights and when the LEDs themselves are used as an information display apparatus. In order to overcome this problem, there are a method of selectively using LEDs with similar characteristics among the LEDs manufactured on one substrate and a method of driving LEDs by compensating for a difference between light emission characteristics when the LEDs are driven later. The method of selectively using LEDs with similar characteristics on a substrate results in a significant cost. In addition, the method of driving LEDs by compensating according to measured characteristic parameters of the LEDs at a factory does not reflect degradation of characteristics of the LEDs which occurs during use.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a new concept and structure of an economical display using a light emitting diode.

Furthermore, the following description relates to an efficient method for compensating for degradation of characteristics of a light emitting diode which occurs during use thereof in an information display apparatus.

In one general aspect, an image, which is displayed at a low resolution by light emitting diodes in a light emitting display panel, is modulated by light modulating devices arranged at a higher resolution than the light emitting diodes in a light modulating panel, which overlaps a front surface of the light emitting display panel, so that display of a high resolution image is achieved. Display modulating data of the light modulating devices is generated from the input high resolution image, and a low resolution image displayed by the light emitting diodes is an image obtained by converting the input high resolution image.

In another general aspect, a low resolution image displayed by light emitting diodes may be a color image.

In still another general aspect, non-uniformity of characteristics of light emitting diodes is adjusted. According to an aspect in which characteristics of light emitting diodes are adjusted, adjustment of non-uniformity of the characteristics of the light emitting diodes may be achieved by adjusting light emission of the light emitting diodes. According to another aspect in which the characteristics of light emitting diodes are adjusted, the adjustment of the non-uniformity of the characteristics of the light emitting diodes may be further achieved by adjusting modulation parameters of light modulating devices.

In yet another general aspect, a light emitting display panel may further include a plurality of light detecting devices each of which is adjacently arranged to a corresponding light emitting diode. A degree of degradation during use of the light emitting diodes is measured by the light detecting device and the degradation during use of the light emitting diodes is compensated for based thereon.

Other features and aspects will be apparent from the following detailed description, the drawings, and the claims.

### BRIEF DESCRIPTION OF THE DRAWINGS

FIG. 1 shows a main portion of a configuration of a display panel of an information display apparatus according to an embodiment.

FIG. 2 is a block diagram showing a configuration of an information display apparatus according to an embodiment.

FIG. 3 is a block diagram showing a configuration of an information display apparatus according to another embodiment.

FIG. 4 is a block diagram showing a configuration of an information display apparatus according to still another embodiment.

FIG. 5 is a block diagram showing a configuration of an information display apparatus according to yet another embodiment.

FIG. 6 is a flowchart showing a configuration of a display control method of an information display apparatus according to an embodiment.

FIG. 7 is a flowchart showing a configuration of a display control method of an information display apparatus according to another embodiment.

FIG. 8 is a flowchart showing a configuration of a display control method of an information display apparatus according to still another embodiment.

FIG. 9 is a flowchart showing a configuration of a display control method of an information display apparatus according to yet another embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

The above-described aspects and additional aspects are embodied through embodiments described with reference to the accompanying drawings. It will be understood that components of each embodiment may be variously combined within one embodiment as long as no other mention thereof or mutual contradiction exists. That is, although a drawing is shown as an embodiment, it should not be understood as being limited to only one embodiment. As will be described in separate optional aspects or additional aspects in the following description, it should be understood that each block represents various embodiments by adding one block or a combination of two or more blocks to essential blocks.

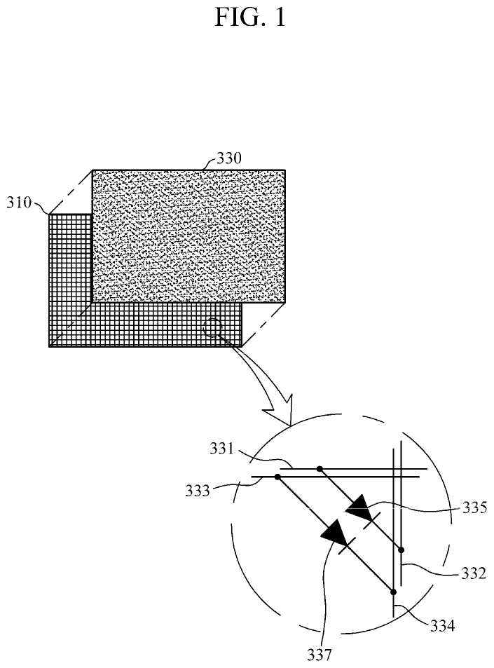

FIG. 1 shows a main portion of a configuration of a display panel of an information display apparatus according to an embodiment. The display panel of the information display apparatus according to the embodiment includes a light emitting display panel 310 and a light modulating panel 330 located on a front surface of the light emitting display panel 310. In an embodiment, the light modulating panel 330 is fixed in close contact with the front surface of the light emitting display panel 310. A plurality of color light emitting diodes (LEDs) are arranged on the light emitting display panel 310. In this embodiment, the color LEDs are LEDs. However, in this specification, the expression “the color LED” should be interpreted as encompassing various techniques for stably outputting light by itself, such as an organic LED (OLED).

In the embodiment as shown in the drawing, in the light emitting display panel, the color LEDs are arranged in a matrix form on a graphite circuit board having thermally isotropic properties. However, the light emitting display panel may be configured in the form of an array in which various shapes, such as a triangular shape, a rhombic shape, a square shape, and a rectangular shape with LEDs located at their vertexes, are repeated. In addition to the LEDs, a driving circuit and circuits for controlling information display may be mounted on the circuit board.

According to an aspect, the light emitting display panel may be a color panel. The LEDs may be arranged such that LEDs of three primary colors constitute one group. In the color panel, the LEDs may be arranged in various forms. Further, a single LED including a plurality of monochromatic light emitting chips may be configured inside a package to display color.

Since the configuration of the light emitting display panel is similar to that of a known LED display, a detailed description thereof will be omitted.

In the light modulating panel 330, a greater number of light modulating devices are arranged per unit area than the number of the LEDs of the light emitting display panel 310 per unit area. Specifically, the light modulating devices may be arranged at a density 4 to 16 times higher than that of the LEDs. When the density of the light modulating devices is much higher than the density of the light emitting devices, display quality of a display image is more dependent on modulation quality of the light modulating devices than display quality of the LEDs. Conversely, when the density of the light modulating devices is not much lower than the density of the LEDs, the display quality of the display image is more dependent on the display quality of the LEDs than the modulation quality of the light modulating devices. In an embodiment, the light modulating panel 330 is a liquid crystal display panel which switches input light with a controlled degree of light and outputs the light. In addition to a thin-film transistor (TFT), a micro-mirror device or the like is known as a light modulator for modulating input light. In the embodiment as shown in the drawing, a unit structure in which liquid crystals oriented between polarizing plates are switched by the active driving of the TFT constitutes one light modulating device. In the embodiment as shown in the drawing, the light modulating panel 330 has a density of TFT light modulating devices four times the number of color pixels of color LEDs. However, the proposed invention is not limited thereto, and the light modulating panel 330 may be designed to have a density of the TFT light modulating devices which is, for example, 5 times, 8 times, 10 times, or 16 times the number of color pixels of color LEDs. In the embodiment as shown in the drawing, a transmission amount of light output from the color pixel is adjusted by switching one color pixel of the light emitting display panel 310 to be spatially different from the corresponding four light modulating devices in the light modulating panel 330 in close contact with the light emitting display panel 310, thereby substantially achieving an additional display resolution. An amount of light entering user's eyes is primarily determined in the color pixel and is additionally limited by the light modulating devices. Therefore, an image having a resolution corresponding to the resolution of the light modulating panel is displayed to the user's eyes.

In another embodiment, a light diffusion plate may be further included between the light emitting display panel 310 and the light modulating panel 330. The light diffusion plate has an effect of adding light emission of the LEDs to each other to perform low pass filtering. When light emission characteristics of some LEDs are degraded, the degradation of the display quality may be effectively improved due to the light diffusion plate. Nevertheless, due to the high resolution light modulation of the light modulating panel 330, the sharpness of the image is not degraded.

According to another aspect, the light emitting display panel may further include a plurality of light detecting devices each of which is adjacently arranged to a corresponding LED. In the embodiment as shown in the drawing, the light detecting devices may be a photo-detector. As another example, the light detecting device may be a photo-diode, a photo-transistor, a complementary metal-oxide-semiconductor (CMOS) image sensor pixel, a charge-coupled device (CCD) image sensor pixel, or the like. In the embodiment as shown in the drawing, both ends of an LED 337 are connected to a column electrode 334 and a row electrode 333, and the LED 337 is driven in a matrix scanning manner. Further, in the embodiment as shown in the drawing, both ends of a light detecting device 335 are connected to a column electrode 332 and a row electrode 331, and the light detecting device 335 is driven in a matrix scanning manner. However, the density or the driving method of the light detecting devices is not limited to that shown in this drawing, and the light detecting devices may be designed using various methods according to a detection period, a detection timing, and a specification of the panel, such as a method of driving the light detecting devices in units of groups by varying an electrode wiring or a method of driving the light detecting devices at separated positions at one time.

The light detecting device 335 measures the light emission characteristic of the LED 337 arranged adjacent thereto, in particular, an amount of light when a reference current is supplied. In the embodiment as shown in the drawing, the light detecting device 335 measures light reflected from the light modulating panel 330 without passing through the light modulating panel 330 among light emitted from the LED 337. Among the LEDs of the light emitting display panel and the light modulating devices of the light modulating panel, at least devices in which the light characteristics are measured currently are required to be driven in a reference state for measurement. For example, the LED to be measured is driven with a reference current, and the light detecting device 335 measures the reflected light in a state in which the corresponding light modulating device is in a reference state, for example, in a state in which a liquid crystal switch is driven in a minimum light transmitting mode. In the embodiment as shown in the drawing, driving circuits for driving the information display apparatus are mounted on the light emitting display panel 310, and the light emitting display panel 310 and the light modulating panel 330 are electrically connected through a connector.

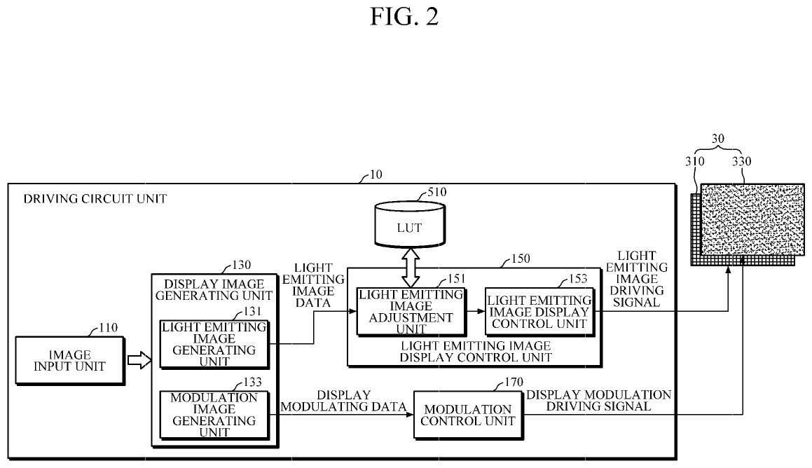

FIG. 2 is a block diagram showing a configuration of an information display apparatus according to an embodiment. According to an aspect, the information display apparatus includes a display panel 30 and a driving circuit unit 10. In the embodiment as shown in the drawing, the display panel 30 includes a light emitting display panel 310 and a light modulating panel 330. A plurality of color LEDs are arranged on the light emitting display panel 310. The light modulating panel 330 is located on a front surface of the light emitting display panel 310. In the light modulating panel 330, a greater number of light modulating devices are arranged per unit area than the number of LEDs of the light emitting display panel 310 per unit area. A configuration of the display panel 30 has been described with reference to FIG. 1.

In the embodiment as shown in the drawing, the driving circuit unit 10 includes a display image generating unit 130, a light emitting image display control unit 150, and a modulation control unit 170. The display image generating unit 130 generates color light emitting image data and display modulating data from an input image. The color light emitting image data is data which will be displayed on the light emitting display panel 310 and is data for controlling light emission of each LED. The display modulating data is data for controlling each of the light modulating devices of the light modulating panel 330. Since the number of light modulating devices is greater than the number of LEDs, a resolution of the color light emitting image data differs from that of the display modulating data according to a ratio of the number of light modulating devices to the number of LEDs.

According to an aspect, the color light emitting image data may be image data obtained by converting an input image to have a low resolution, and the display modulating data may be image data obtained by converting input image data into a monochrome image. In this case, light emitted from one LED is modulated by the plurality of light modulating devices and displayed. For example, light emitted from one LED may be switched by four TFT liquid crystal pixels which are controlled to correspond to an image having four times the resolution, and the image having four times the resolution may be displayed. As another example, light emitted from one color LED may be switched by four TFT liquid crystal pixels which are controlled to correspond to an image having four times the resolution, and a color image having four times the resolution may be displayed. As described above, the color light emitting image data and the display modulating data may be determined differently according to the configuration of the panel. In an embodiment, the display image generating unit 130 may include a light emitting image generating unit 131 and a modulation image generating unit 133. In an embodiment, the light emitting image generating unit 131 converts an input image to have a low resolution to generate color light emitting image data. In an embodiment, the modulation image generating unit 133 converts the input image into a monochrome image to generate display modulating data.

The light emitting image display control unit 150 generates a light emitting image driving signal by reflecting a light emitting adjustment value in the color light emitting image data to output the light emitting image driving signal to the light emitting display panel.

In this specification, the term “calibration” refers to a measure to eliminate non-uniformity of characteristics of devices caused by non-uniformity of a process during manufacturing. In this specification, the term “compensation” refers to a measure to eliminate degradation or non-uniformity of characteristics caused by degradation during use of devices. In this specification, the term “adjustment” refers to a measure to eliminate degradation or non-uniformity of characteristics of devices, including calibration and compensation.

In an embodiment, the light emitting image display control unit 150 may include a light emitting image adjustment unit 151 and a light emitting image driving unit 153. The light emitting image adjustment unit 151 generates light emitting image driving data obtained by reflecting a light emitting adjustment value for adjusting non-uniformity of characteristics of the LEDs in the color light emitting image data and outputs the light emitting image driving data. For example, the light emitting adjustment value may be an offset that should be added to the color light emitting image data to adjust the non-uniformity of the characteristics of the LEDs. As another example, the light emitting adjustment value may be a coefficient value that should be multiplied by the color light emitting image data to adjust the non-uniformity of the characteristics of the LEDs.

According to an aspect, the information display apparatus may further include a memory 510 configured to store the light emitting adjustment value for adjusting the non-uniformity of the characteristics of the LEDs. In an embodiment, the light emitting adjustment value may be stored in an electrically erasable programmable read only memory (EEPROM) having a storage capacity which is equal to the resolution of the color light emitting image data. In another embodiment, the light emitting adjustment value may be stored in a flash memory having a storage capacity which is equal to the resolution of the color light emitting image data. In the embodiment as shown in the drawing, the light emitting adjustment value is an offset value which is added for each color light emitting image data of each LED and is stored in the memory 510 in the form of a look-up table. However, the proposed invention is not limited thereto, and for example, the light emitting adjustment value may be implemented in a method of implementing coefficients of an approximate conversion function as logic, or in a method of storing only coefficient values in a non-volatile memory. The approximate conversion function may be a form of a polynomial function, such as a cubic function, a quintic function, or the like.

The light emitting adjustment value may be, for example, a light emitting calibration value for calibrating non-uniformity of display characteristics of the LEDs of the light emitting display panel during manufacturing. For example, the light emitting adjustment value may be calculated by measuring a light emission characteristic of each of the LEDs during manufacturing and determining a degree of non-uniformity of the light emission characteristics. As another example, the light emitting adjustment value may be a light emitting compensation value for compensating for the non-uniformity of the display characteristics of the LEDs caused by degradation during use of the light emitting display panel. For example, the light emitting compensation value may be input by a service man through the measurement of the display quality periodically during use. As another example, the light emitting compensation value may be calculated based on a statistical model and may be periodically downloaded from a server to the information display apparatus.

The light emitting image driving unit 153 generates a light emitting image driving signal from the light emitting image driving data and outputs the light emitting image driving signal. For example, the light emitting image driving signal may be a pulse train of a number proportional to a magnitude of the light emitting image driving data. As another example, the light emitting image driving signal may be an amplitude modulation signal having a pulse width proportional to the magnitude of the light emitting image driving data.

The modulation control unit 170 outputs a display modulation driving signal which is generated from the display modulating data, to the light modulating panel. The display modulation driving signal controls modulation of each of the light modulating devices of the light modulating panel. In an embodiment, the display modulation driving signal is a TFT driving voltage signal for driving each of TFT liquid crystal pixels of the light modulating panel.

In the embodiment as shown in the drawing, the image input unit 110 receives one image signal or a plurality of image signals of various types, converts the image signals into signals of a format to be suitable for internal processing, and outputs the signals. For example, the image input unit 110 may receive a digital image signal in a red, green, and blue (RGB) format from a broadcasting tuner. As another example, the image input unit 110 may receive a digital image signal in a YUV format stored in the memory. As still another example, the image input unit 110 may receive an analog high density (HD) format signal, decode the analog HD format signal, convert the decoded analog HD format signal into a digital RGB format signal, and then output the digital RGB format signal.

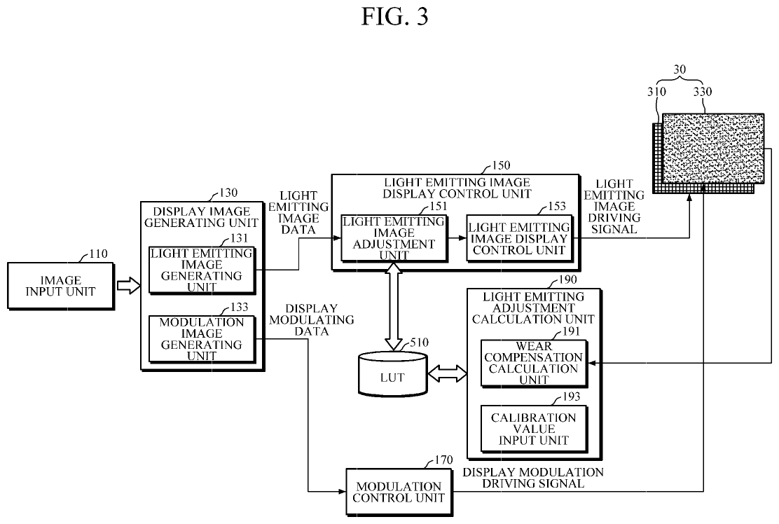

FIG. 3 is a block diagram showing a configuration of an information display apparatus according to another embodiment. In the drawing, blocks with names similar to the embodiment shown in FIG. 2 have similar functions to the corresponding blocks of the embodiment shown in FIG. 2 and are referred to by the same reference numerals. The embodiment shown in FIG. 3 differs from the embodiment shown in FIG. 2 in that the information display apparatus further includes a light emitting adjustment calculation unit 190. The light emitting adjustment calculation unit 190 stores the light emitting adjustment value for each LED in the memory 510. According to an aspect, the light emitting adjustment calculation unit 190 may include a calibration value input unit 193. The calibration value input unit 193 stores a light emitting calibration value inputted from the outside in the memory 510. In an embodiment, the calibration value input unit 193 may be a connector which fetches an address bus and a data bus of the memory 510 to the outside. As another example, the calibration value input unit 193 may be a serial interface which writes data to the memory 510. For example, the light emitting calibration value may be calculated from a degree of non-uniformity of a light emission characteristic of each of the LEDs by measuring the light emission characteristic of each of the LEDs during manufacturing and may be stored in the memory 510 implemented as an EEPROM through the calibration value input unit 193.

According to an aspect, the light emitting display panel may further include a plurality of light detecting devices each of which is adjacently arranged to a corresponding LED. The arrangement of the light detecting devices has been described above with reference to FIG. 1. According to an aspect, the light emitting adjustment calculation unit 190 may include a degradation compensation calculation unit 191. The degradation compensation calculation unit 191 calculates a light emitting compensation value for each LED on the basis of a brightness value measured through the light detecting devices in response to a check event for checking display quality during use and stores the calculated light emitting compensation value in the memory 510. For example, the check event may be a timer event that occurs at regular intervals, such as a week, a month, and the like. As another example, the check event may be an operation event which is input by a user for compensation for display quality.

When the check event occurs, the degradation compensation calculation unit 191 drives the LEDs with reference brightness and measures a brightness value through the light detecting devices. A reference brightness value may be stored in a predetermined region of the memory 510, for example, in the form of a test image for measurement. When the image for measurement is displayed, the light modulating panel may be driven to completely block transmitted light, thereby preventing a screen from being brightly displayed from the outside. The characteristics of the LEDs may be sequentially measured starting with one LED, may be measured row by row or column by column, or may be sequentially measured for each measurement group defined by skipping several pixels in order to increase a measurement speed while excluding the influence of the measurement of the adjacent pixels. An offset value may be determined as a degree to which the measured brightness value deviates from the reference brightness value. Further, degradation of a nonlinear or linear characteristic of the light emission characteristic for each driving current may be measured by measuring two or three brightness values for each LED, and thus a compensation coefficient may be determined. The measured light emitting compensation value may be stored in the memory 510 in the form of a look-up table.

In another embodiment, the degradation compensation calculation unit 191 calculates a light emitting compensation value for each LED on the basis of a brightness value measured through the light detecting devices in response to a check event for checking display quality during use, calculates a light emitting adjustment value by adding the calculated light emitting compensation value to the light emitting calibration value, and stores the calculated light emitting adjustment value in the memory 510 in the form of a look-up table.

When one LED or a relatively small number of the LEDs completely stops emitting light or a degree of light emission is very small, it is possible to compensate for the influence of the occurrence of defects in the corresponding LED by adding a large offset to the brightness of the surrounding LEDs. That is, according to the aspect of the proposed invention, compensation of a brightness value of a specific LED may be achieved not only by compensating for brightness of the corresponding LED but also by compensating for the brightness of the surrounding LEDs.

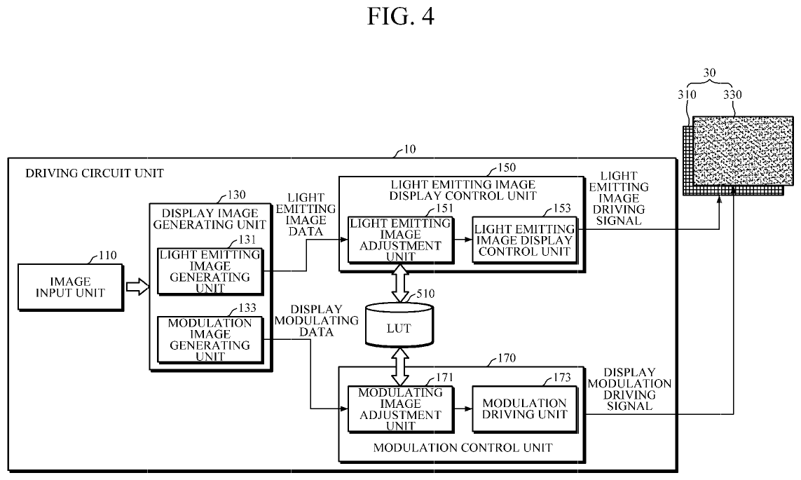

FIG. 4 is a block diagram showing a configuration of an information display apparatus according to still another embodiment. In the drawing, blocks with names similar to the embodiment shown in FIG. 2 have similar functions to the corresponding blocks of the embodiment shown in FIG. 2 and are referred to by the same reference numerals. The embodiment shown in FIG. 4 differs from the embodiment shown in FIG. 2 in that a modulation control unit 170 includes a modulating image adjustment unit 171 and a modulation driving unit 173.

According to an aspect, a light emitting adjustment value for calibrating non-uniformity of characteristics of the LEDs and a modulation adjustment value of the light modulating devices for compensating for the non-uniformity of the characteristics of the LEDs are stored in the memory 510.

The light emitting adjustment value may be, for example, a light emitting calibration value for calibrating non-uniformity of display characteristics of the LEDs of the light emitting display panel during manufacturing. As another example, the light emitting adjustment value may be a light emitting compensation value for compensating for the non-uniformity of the display characteristics of the LEDs caused by degradation during use of the light emitting display panel. For example, the light emitting compensation value may be input by a service man through the measurement of the display quality periodically during use. As another example, the light emitting compensation value may be calculated based on a statistical model and may be periodically downloaded from a server to the information display apparatus.

The light emitting adjustment value may be prepared in the form of, for example, an offset or in the form of a look-up table. As another example, the light emitting adjustment value may be a value reflecting both of the light emitting calibration value and the light emitting compensation value, for example, a sum of two offsets, or may be prepared in the form of a single look-up table in which compensation and correction are all reflected. According to an aspect, the modulating image adjustment unit 171 generates display modulation driving data by reflecting the modulation adjustment value in the display modulating data.

In the embodiment as shown in the drawing, the non-uniformity of the characteristics of the LEDs is adjusted and relieved in the light emitting display panel itself by adjusting the light emission of the LEDs in one case and is adjusted and relieved in the light modulating panel by adjusting a degree of modulation of the light modulating devices on another case. The adjustment of the light emission of the LEDs results in a limitation of the light emission characteristics. For example, when it is assumed that the LED displays with luminance in a range of 0 to 100, when the light emitting adjustment value has a size of 10 as an offset, a display luminance range of the corresponding pixel is limited to a range of 0 to 90. Similarly, the adjustment of the modulation of the light modulating devices results in a limitation of the modulation characteristics. For example, when it is assumed that the light modulating devices are capable of modulating input light in a range of 0 to 100, when the modulation adjustment value has a size of 5 as an offset, a modifiable range of the corresponding pixel is limited to a range of 0 to 95. According to the aspect of the proposed invention, the adjustment of the characteristics of the LEDs may be divided and distributed into the adjustment of the light emission of the LEDs and the adjustment of the modulation of the light modulating devices. The modulation driving unit 173 generates a display modulation driving signal from the generated display modulation driving data and outputs the display modulation driving signal to the light modulating panel.

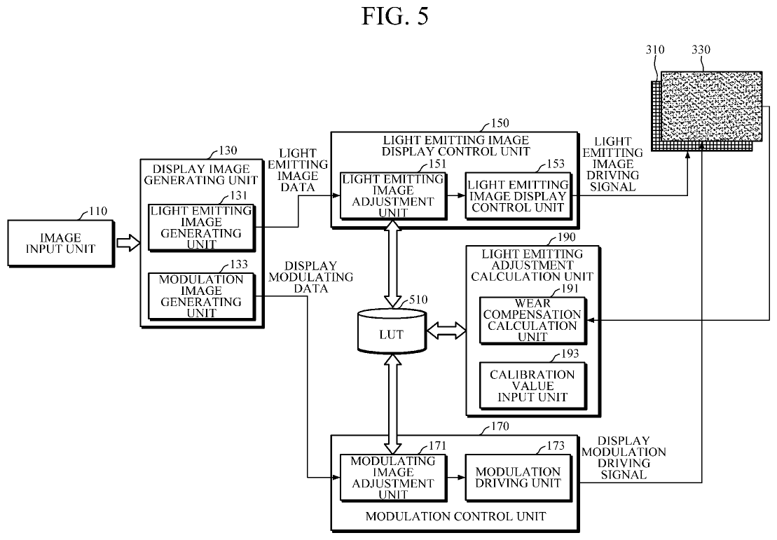

FIG. 5 is a block diagram showing a configuration of an information display apparatus according to yet another embodiment. In the drawing, blocks with names similar to the embodiment shown in FIG. 2 have similar functions to the corresponding blocks of the embodiment shown in FIG. 2 and are referred to by the same reference numerals. The embodiment shown in FIG. 5 differs from the embodiment shown in FIG. 2 in that the information display apparatus further includes a light emitting adjustment calculation unit 190, and a modulation control unit 170 includes a modulating image adjustment unit 171 and a modulation driving unit 173.

Similar to the embodiment shown in FIG. 3, the modulating image adjustment unit 171 generates display modulation driving data by reflecting a modulation adjustment value to display modulating data. According to an aspect, a light emitting adjustment value of the LEDs for adjusting the non-uniformity of the characteristics of the LEDs and a modulation adjustment value of the light modulating devices for adjusting the non-uniformity of the characteristics of the LEDs are stored in the memory 510. According to an aspect, the light emitting adjustment calculation unit 190 may include a calibration value input unit 193. The light emitting calibration value of the LEDs for calibrating the non-uniformity of the characteristics of the LEDs and the modulation calibration value of the light modulating devices for calibrating the non-uniformity of the characteristics of the LEDs are calculated by measuring light emission characteristics of each of the LEDs during manufacturing and determining a degree of non-uniformity of the light emission characteristics. The calibration value for calibrating the non-uniformity of the light emission characteristics of the LEDs during manufacturing is distributed into the light emitting calibration value and the modulation calibration value.

According to an aspect, the calibration value input unit 193 stores the light emitting calibration value and the modulation calibration value inputted from the outside in the memory 510. In an embodiment, the calibration value input unit 193 may be a connector which fetches an address bus and a data bus of the memory 510 to the outside. As another example, the calibration value input unit 193 may be a serial interface which writes data to the memory 510. For example, the light emitting calibration value, that is, the light emitting calibration value and the modulation calibration value in this embodiment, may be calculated from a degree of non-uniformity of the light emission characteristic of each of the LEDs by measuring the light emission characteristic of each of the LEDs during manufacturing and may be stored in the memory 510 implemented as an EEPROM through the calibration value input unit 193.

According to an aspect, the light emitting display panel may further include a plurality of light detecting devices each of which is adjacently arranged to a corresponding LED. The arrangement of the light detecting devices has been described above with reference to FIG. 1. According to an aspect, the light emitting adjustment calculation unit 190 may include a degradation compensation calculation unit 191. The degradation compensation calculation unit 191 calculates a light emitting compensation value for each LED and a modulation compensation value for each light modulating device on the basis of a brightness value measured through the light detecting devices in response to a check event for checking display quality during use and stores the calculated light emitting compensation value in the memory 510. For example, the check event may be a timer event that occurs at regular intervals, such as a week, a month, and the like. As another example, the check event may be an operation event which is input by a user for compensation for display quality. When the check event occurs, the degradation compensation calculation unit 191 drives the LEDs with reference brightness and measures a brightness value through the light detecting devices. A reference brightness value may be stored in a predetermined region of the memory 510, for example, in the form of a test image for measurement. When the image for measurement is displayed, the light modulating panel may be driven to completely block transmitted light, thereby preventing a screen from being brightly displayed from the outside. The characteristics of the LEDs may be sequentially measured starting with one LED, may be measured row by row or column by column, or may be sequentially measured for each measurement group defined by skipping several pixels in order to increase a measurement speed while excluding the influence of the measurement of the adjacent pixels. An offset value may be determined as a degree to which the measured brightness value deviates from the reference brightness value. Further, degradation of a nonlinear or linear characteristic of the light emission characteristic for each driving current may be measured by measuring two or three brightness values for each LED, and thus a compensation coefficient may be determined. In this embodiment, compensation for a difference in the light emission characteristic for each LED is achieved by compensating for both of the driving of the LED and the driving of the light modulating device. The distribution of the compensation may be determined in consideration of a degree of compensation, characteristics of the LED, and characteristics of the light modulating device, which are required. The calculated light emitting compensation value and the calculated modulation compensation value may be stored in the memory 510 in the form of a look-up table. As another example, the light emitting compensation value may be added to the light emitting calibration value and stored as the light emitting adjustment value, and the modulation compensation value may be added to the modulation calibration value and stored as the modulation adjustment value.

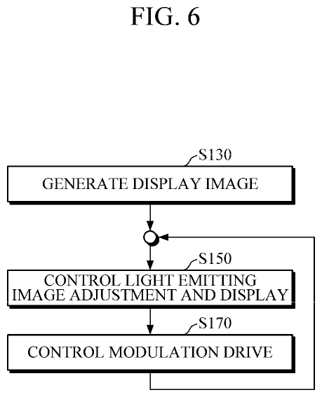

FIG. 6 is a flowchart showing a configuration of a display control method of an information display apparatus according to an embodiment. According to an aspect, the information display apparatus to which the proposed display control method is applied includes a light emitting display panel, in which a plurality of color LEDs are arranged, and a light modulating panel which is located on a front surface of the light emitting display panel and in which a greater number of light modulating devices are arranged per unit area than the number of LEDs of the light emitting display panel per unit area.

According to an aspect, the display control method of the information display apparatus according to the embodiment includes a display image generating operation S130, a light emitting image adjustment and display control operation S150, and a modulation drive control operation S170. In the display image generating operation S130 of the display control method, color light emitting image data and display modulating data are generated from an input image. In the embodiment as shown in the drawing, the color light emitting image data is generated by converting the input image to a low resolution image corresponding to a resolution of the light emitting display panel. In the embodiment as shown in the drawing, the display modulating data is generated by converting the input image into a monochrome image at a resolution corresponding to the resolution of the light modulating panel.

In the light emitting image adjustment and display control operation S150 of the display control method, a light emitting image driving signal is generated by reflecting a light emitting adjustment value to the color light emitting image data and is output to the light emitting display panel. The light emitting adjustment value may be, for example, a light emitting calibration value for calibrating non-uniformity of display characteristics of the LEDs of the light emitting display panel during manufacturing. As another example, the light emitting adjustment value may be a light emitting compensation value for compensating for the non-uniformity of the display characteristics of the LEDs caused by degradation during use of the light emitting display panel. For example, the light emitting compensation value may be input by a service man through the measurement of the display quality periodically during use. As another example, the light emitting compensation value may be calculated based on a statistical model and may be periodically downloaded from a server to the information display apparatus.

The light emitting adjustment value may be prepared in the form of, for example, an offset or in the form of a look-up table. As another example, the light emitting adjustment value may be a value reflecting both of the light emitting calibration value and the light emitting compensation value, for example, a sum of two offsets, or may be prepared in the form of a single look-up table in which compensation and correction are all reflected. The light emitting image driving signal is an electrical signal obtained by converting the adjusted color light emitting image data so as to drive the light emitting display panel. Such a driving signal may be generated to meet panel specifications of commercialized driving chips.

In the modulation drive control operation S170 of the display control method, a display modulation driving signal generated from the display modulating data is output to the light modulating panel. The display modulation driving signal is an electrical signal obtained by converting the display modulating data so as to drive the light modulating devices of the light modulating panel. Such a driving signal may be generated to meet panel specifications of commercialized driving chips.

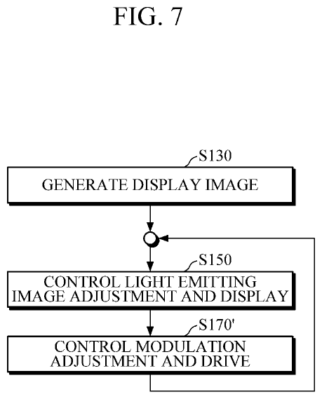

FIG. 7 is a flowchart showing a configuration of a display control method of an information display apparatus according to another embodiment. According to an aspect, the display control method of the information display apparatus according to the embodiment includes a display image generating operation S130, a light emitting image adjustment and display control operation S150, and a modulation adjustment and drive control operation S170′.

In the display image generating operation S130 of the display control method, color light emitting image data and display modulating data are generated from an input image. In the embodiment as shown in the drawing, the color light emitting image data is generated by converting the input image to a low resolution image corresponding to a resolution of the light emitting display panel. In the embodiment as shown in the drawing, the display modulating data is generated by converting the input image into a monochrome image at a resolution corresponding to the resolution of the light modulating panel.

In the light emitting image adjustment and display control operation S150 of the display control method, a light emitting image driving signal is generated by reflecting a light emitting adjustment value in color light emitting image data and is output to the light emitting display panel. The light emitting adjustment value may be, for example, a light emitting calibration value for calibrating non-uniformity of display characteristics of the LEDs of the light emitting display panel during manufacturing. As another example, the light emitting adjustment value may be a light emitting compensation value for compensating for the non-uniformity of the display characteristics of the LEDs caused by degradation during use of the light emitting display panel. For example, the light emitting compensation value may be input by a service man through measurement of display quality periodically during use. As another example, the light emitting compensation value may be calculated based on a statistical model and may be periodically downloaded to the information display apparatus from a server.

The light emitting adjustment value may be prepared in the form of, for example, an offset or in the form of a look-up table. As another example, the light emitting adjustment value may be a value reflecting both of the light emitting calibration value and the light emitting compensation value, for example, a sum of two offsets, or may be prepared in the form of a single look-up table in which compensation and correction are all reflected. The light emitting image driving signal is an electrical signal obtained by converting the adjusted color light emitting image data so as to drive the light emitting display panel. Such a driving signal may be generated to meet panel specifications of commercialized driving chips.

In the modulation adjustment and drive control operation S170′ of the display control method, a display modulation driving signal is generated by reflecting a modulation adjustment value in the display modulating data and is output to the light modulating panel.

The modulation adjustment value may be, for example, a modulation calibration value for calibrating the non-uniformity of the display characteristics of the LEDs of the light emitting display panel during manufacturing. As another example, the modulation adjustment value may be a modulation compensation value for compensating for the non-uniformity of the display characteristics of the LEDs caused by degradation during use of the light emitting display panel. For example, the modulation compensation value may be input by a service man through the measurement of the display quality periodically during use. As another example, the modulation compensation value may be calculated based on a statistical model and may be periodically downloaded from a server to the information display apparatus.

The modulation adjustment value may be prepared in the form of, for example, an offset or in the form of a look-up table. As another example, the modulation adjustment value may be a value reflecting both of the modulation calibration value and the modulation compensation value, for example, a sum of two offsets, or may be prepared in the form of a single look-up table in which compensation and correction are all reflected.

The display modulation driving signal is an electrical signal obtained by converting the display modulating data so as to drive the light modulating devices of the light modulating panel. Such a driving signal may be generated to meet panel specifications of commercialized driving chips.

In the embodiment as shown in the drawing, non-uniformity of the display quality of the light emitting display panel is distributed and relieved by adjustment of light emission and adjustment of modulation. The non-uniformity of the display characteristics of the light emitting display panel during manufacturing is measured and the light emitting calibration value and the modulation calibration value for calibrating the non-uniformity are calculated. Further, for example, degradation of the display characteristics of the light emitting display panel may be measured by a service man through the measurement of the display quality periodically during use, and the light emitting compensation value and the modulation compensation value for calibrating the degradation and the non-uniformity may be calculated. As another example, the light emitting compensation value and the modulation compensation value may be calculated based on a statistical model and may be periodically downloaded from a server to the information display apparatus. The light emitting calibration value and the light emitting compensation value may be integrated into one look-up table, and the modulation calibration value and the modulation compensation value may be integrated into another look-up table.

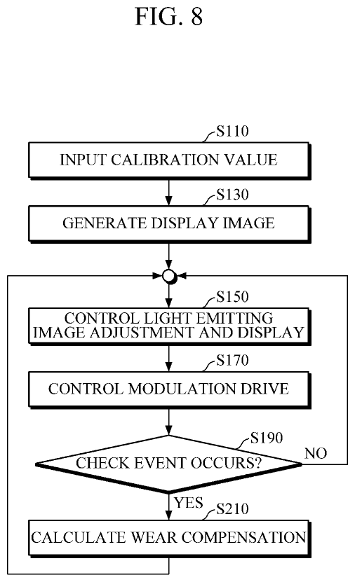

FIG. 8 is a flowchart showing a configuration of a display control method of an information display apparatus according to still another embodiment. According to an aspect of the proposed invention, the display control method of the information display apparatus may further include a calibration value input operation S110. In the calibration value input operation S110 of the display control method according to the embodiment, a light emitting calibration value inputted from the outside is stored in an internal memory, for example, an EEPROM. The light emitting calibration value may be calculated, for example, in the form of a look-up table by measuring display characteristics of the light emitting display panel during manufacturing and may be recorded directly in the EEPROM through a connector. Since the display image generating operation S130 is similar to that in the embodiment of FIG. 6, a description thereof will be omitted.

According to another aspect of the proposed invention, in the display control method of the information display apparatus, it is possible to compensate for degradation of the LED. According to the aspect, the display control method of the information display apparatus may further include a check event checking operation S190 and a degradation compensation calculating operation S210. In the check event checking operation S190 of the display control method, it is checked whether a check event has occurred. For example, the check event may occur by checking whether a predetermined time or greater has elapsed since the occurrence of the previous check event. As another example, the check event may occur due to interrupt at any time. For example, the check event may occur from an independent timer event.

In the degradation compensation calculating operation S210 of the display control method, a light emitting compensation value for each LED is calculated based on a brightness value measured through the light detecting devices each of which is adjacently arranged to a corresponding LED in response to the check event for checking the display quality during use, and thus the calculated light emitting compensation value is stored in the memory.

According to another aspect, in the degradation compensation calculating operation S210 of the display control method, a light emitting compensation value for each LED may be calculated based on a brightness value measured through the light detecting devices each of which is adjacently arranged to a corresponding LED in response to the check event for checking the display quality during use, and a light emitting adjustment value obtained by adding the calculated light emitting compensation value to a light emitting calibration value may be stored in the memory. Here, the memory may be an internal non-volatile memory, for example, a flash memory. The specific configuration of the degradation compensation calculation is the same as that described with reference to FIGS. 2 and 5.

In the display image generating operation S130 of the display control method, color light emitting image data and display modulating data are generated from an input image. In the embodiment as shown in the drawing, the color light emitting image data is generated by converting the input image to a low resolution image corresponding to a resolution of the light emitting display panel. In the embodiment as shown in the drawing, the display modulating data is generated by converting the input image into a monochrome image at a resolution corresponding to the resolution of the light modulating panel.

In the light emitting image adjustment and display control operation S150 of the display control method, a light emitting image driving signal is generated by reflecting a light emitting adjustment value to the color light emitting image data and is output to the light emitting display panel. The light emitting adjustment value may be the light emitting calibration value stored in the memory. As another example, the light emitting adjustment value may be the light emitting compensation value stored in the memory. As still another example, the light emitting adjustment value may include both of the light emitting calibration value and the light emitting compensation value which are stored in the memory. As yet another example, the light emitting adjustment value may be a single value reflecting both of the light emitting calibration value and the light emitting compensation value, for example, a sum of two offsets, or may be prepared in the form of a single look-up table in which compensation and correction are all reflected.

The light emitting image driving signal is an electrical signal obtained by converting the adjusted color light emitting image data so as to drive the light emitting display panel. Such a driving signal may be generated to meet panel specifications of commercialized driving chips.

In the modulation drive control operation S170 of the display control method, a display modulation driving signal generated from the display modulating data is output to the light modulating panel. The display modulation driving signal is an electrical signal obtained by converting the display modulating data so as to drive the light modulating devices of the light modulating panel. Such a driving signal may be generated to meet panel specifications of commercialized driving chips.

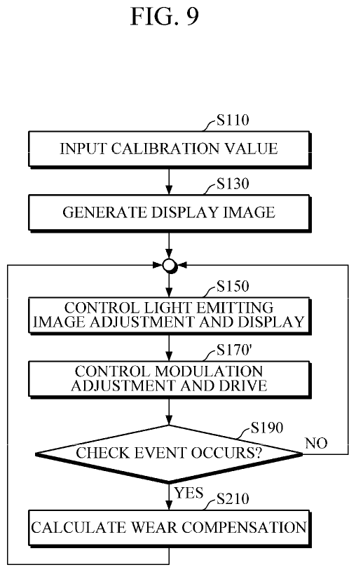

FIG. 9 is a flowchart showing a configuration of a display control method of an information display apparatus according to yet another embodiment. According to an aspect of the proposed invention, the display control method of the information display apparatus may further include a calibration value input operation S110. In the calibration value input operation S110 of the display control method according to the embodiment, a calibration value inputted from the outside is stored in an internal memory, for example, an EEPROM. In the embodiment as shown in the drawing, the calibration value includes a light emitting calibration value and a modulation calibration value. In the embodiment as shown in the drawing, non-uniformity of display quality between the devices of the light emitting display panel during manufacturing are distributed and relieved by calibration of light emission and calibration of modulation. Non-uniformity of display characteristics of the light emitting display panel during manufacturing is measured, and the light emitting calibration value and the modulation calibration value for calibrating the non-uniformity are calculated. The non-uniformity is calibrated by two independent variables, which increases a degree of freedom of calibration. The light emitting calibration value and the modulation calibration value may be distributed for calibration, for example, by measuring the display characteristics of the light emitting display panel during manufacturing, calculated in the form of a look-up table, and recorded directly in the EEPROM through a connector.

According to another aspect of the proposed invention, in the display control method of the information display apparatus, it is possible to compensate for degradation of the LED. According to the aspect, the display control method of the information display apparatus may further include a check event checking operation S190 and a degradation compensation calculating operation S210. In the check event checking operation S190 of the display control method, it is checked whether a check event has occurred. For example, the check event may occur by checking whether a predetermined time or greater has elapsed since the occurrence of the previous check event. As another example, the check event may occur due to interrupt at any time. For example, the check event may occur from an independent timer event.

In the degradation compensation calculating operation S210 of the display control method, a light emitting compensation value for each LED and a modulation compensation value for each light modulating device are calculated based on a brightness value measured through the light detecting devices each of which is adjacently arranged to a corresponding LED in response to the check event for checking the display quality during use, and thus the calculated light emitting compensation value and the calculated modulation compensation value are stored in the memory.

According to another aspect, in the degradation compensation calculating operation S210 of the display control method, the light emitting compensation value for each LED and the modulation compensation value for each light modulating device may be calculated based on the brightness value measured through the light detecting devices each of which is adjacently arranged to a corresponding LED in response to the check event for checking the display quality during use, a light emitting adjustment value and a modulation adjustment value may be calculated by adding the light emitting compensation value and the modulation compensation value to the light emitting calibration value and the modulation calibration value, respectively, and the calculated light emitting adjustment value and the calculated modulation adjustment value may be stored in the memory. Here, the memory may be an internal non-volatile memory, for example a flash memory. The specific configuration of the degradation compensation calculation is the same as that described with reference to FIGS. 2 and 5.

In the display image generating operation S130 of the display control method, color light emitting image data and display modulating data are generated from the input image. In the embodiment as shown in the drawing, the color light emitting image data is generated by converting the input image to a low resolution image corresponding to a resolution of the light emitting display panel. In the embodiment as shown in the drawing, the display modulating data is generated by converting the input image into a monochrome image at a resolution corresponding to the resolution of the light modulating panel.

In the light emitting image adjustment and display control operation S150 of the display control method, a light emitting image driving signal is generated by reflecting a light emitting adjustment value in color light emitting image data and is output to the light emitting display panel. The light emitting adjustment value may include both of the light emitting calibration value and the light emitting compensation value which are stored in the memory. As another example, the light emitting adjustment value may be a single value reflecting both of the light emitting calibration value and the light emitting compensation value, for example, a sum of two offsets, or may be prepared in the form of a single look-up table in which compensation and correction are all reflected.

The light emitting image driving signal is an electrical signal obtained by converting the adjusted color light emitting image data so as to drive the light emitting display panel. Such a driving signal may be generated to meet panel specifications of commercialized driving chips.

In the modulation adjustment and drive control operation S170′ of the display control method, a display modulation driving signal is generated by reflecting a modulation adjustment value in the display modulating data and is output to the light modulating panel. The modulation adjustment value may include both of the modulation calibration value and the modulation compensation value which are stored in the memory. As another example, the modulation adjustment value may be a single value reflecting both of the modulation calibration value and the modulation compensation value, for example, a sum of two offsets, or may be prepared in the form of a single look-up table in which compensation and correction are all reflected.

The display modulation driving signal is an electrical signal obtained by converting the adjusted display modulating data so as to drive the light modulating panel. Such a driving signal may be generated to meet panel specifications of commercialized driving chips.

In the embodiment as shown in the drawing, the non-uniformity of the display quality between the devices of the light emitting display panel that occurs during use is distributed and relieved by adjustment of light emission and adjustment of modulation. The non-uniformity of the display characteristics of the light emitting display panel during use is measured by the light detecting device adjacent to the corresponding LED, and the light emitting compensation value and the modulation compensation value for compensating for the non-uniformity are calculated.

According to the present invention, a light emitting display panel in which LEDs are arranged at a relatively low density can be coupled to a light modulating panel that can be produced with uniform quality at a relatively low cost, and thus a high-resolution, high-quality display can be provided at a relatively low cost.

Non-uniformity of light emission characteristics of the LEDs can be effectively compensated, and thus a display can be manufactured at a much lower cost.

Since degradation during use of light emission characteristics is compensated for, durability can be improved and display quality can be maintained for a longer time.

While exemplary embodiments of the present invention have been described with reference to the accompanying drawing, the present invention is not limited to the exemplary embodiments. It should be interpreted that various modifications that can be apparently made by those skilled in the art are included in the scope of the present invention. The described aspects are capable of being freely combined without departing from each other, and all such combinations are included in the scope of the present invention. For example, it can be easily understood that the embodiments of FIGS. 3, 4, and 5 are different from the embodiment of FIG. 2, or additional configurations thereof can be applied in various combinations to the basic embodiment of FIG. 2.

The appended claims are intended to cover such combinations and the embodiments with omitted or simplified drawing, and do not claim all such combinations. Such combinations should be allowed to enter the scope of the present invention by correction later.

The current embodiments can be implemented as computer readable codes in a computer readable record medium. Codes and code segments constituting the computer program can be easily inferred by a skilled computer programmer in the art. The computer readable recording medium includes all types of record media in which computer readable data are stored. Examples of the computer readable record medium include a read-only memory (ROM), a random access memory (RAM), a compact disc ROM (CD-ROM), a magnetic tape, a floppy disk, and an optical data storage. Further, the record medium may be implemented in the form of a carrier wave such as Internet transmission. In addition, the computer readable record medium may be distributed to computer systems over a network in which computer readable codes may be stored and executed in a distributed manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations fall within the scope of the following claims.

What is claimed is:

1. An information display apparatus comprising:
a light emitting display panel in which a plurality of light emitting diodes are arranged;
a light modulating panel which is located on a front surface of the light emitting display panel and in which a greater number of light modulating devices are arranged per unit area than a number of light emitting diodes per unit area of the light emitting display panel;
a display image generating unit configured to generate light emitting image data and display modulating data from an input image;
a light emitting image display control unit configured to generate a light emitting image driving signal by reflecting a light emitting adjustment value to the light emitting image data and output the light emitting image driving signal to the light emitting display panel; and
a modulation control unit configured to output a display modulation driving signal generated from the display modulating data to the light modulating panel.

2. The information display apparatus of claim 1, wherein the light emitting display panel is a color light emitting display panel in which light emitting diodes of different colors are arranged.

3. The information display apparatus of claim 2, wherein the light modulating devices are arranged at a density of 4 to 16 times higher than that of the light emitting diodes.

4. The information display apparatus of claim 1, wherein the light emitting image data is image data obtained by converting the input image to a low resolution image, and the display modulating data is image data obtained by converting the input image into a monochrome image.

5. The information display apparatus of claim 1, further comprising a memory configured to store the light emitting adjustment value for adjusting non-uniformity of characteristics of the light emitting diodes.

6. The information display apparatus of claim 5, further comprising a calibration value input unit configured to store a light emitting calibration value, which is inputted from the outside, in the memory.

7. The information display apparatus of claim 5, wherein the light emitting display panel further includes a plurality of light detecting devices each of which is adjacently arranged to a corresponding light emitting diode, and
the information display apparatus further includes a degradation compensation calculation unit configured to calculate a light emitting compensation value for each light emitting diode on the basis of a brightness value measured through the light detecting device in response to a check event for checking display quality during use and store the calculated light emitting compensation value in the memory.

8. The information display apparatus of claim 5, wherein the light emitting display panel further includes a plurality of light detecting devices each of which is adjacently arranged to a corresponding light emitting diode, and
the information display apparatus further includes a light emitting adjustment calculation unit including a calibration value input unit configured to receive a light emitting calibration value for calibrating the non-uniformity of the characteristics of the light emitting diodes during manufacturing from the outside and store the light emitting calibration value in the memory, and a degradation compensation calculation unit configured to calculate a light emitting adjustment value by adding a light emitting compensation value for each light emitting diode calculated on the basis of a brightness value measured through the light detecting devices to the light emitting calibration value in response to a check event for checking display quality during use and configured to store the calculated light emitting adjustment value in the memory.

9. The information display apparatus of claim 1, wherein the modulation control unit includes:
a modulating image adjustment unit configured to generate display modulation driving data by reflecting a modulation adjustment value for compensating for non-uniformity of characteristics of the light emitting diodes in the display modulating data; and
a modulation driving unit configured to generate a display modulation driving signal from the generated display modulation driving data and output the display modulation driving signal to the light modulating panel.

10. The information display apparatus of claim 9, further comprising a memory configured to store the light emitting adjustment value of the light emitting diodes for adjusting the non-uniformity of the characteristics of the light emitting diodes and the modulation adjustment value of the light modulating devices for adjusting the non-uniformity of the characteristics of the light emitting diodes.

11. The information display apparatus of claim 10, further comprising a calibration value input unit configured to store a light emitting calibration value and a modulation calibration value which are inputted from the outside in the memory.

12. The information display apparatus of claim 10, wherein the light emitting display panel further includes a plurality of light detecting devices each of which is adjacently arranged to a corresponding light emitting diode, and
the information display apparatus further includes a degradation compensation calculation unit configured to calculate a light emitting compensation value for each light emitting diode and a modulation compensation value for each light modulating device on the basis of a brightness value measured through the light detecting devices in response to a check event for checking display quality during use and configured to store the calculated light emitting compensation value and the calculated modulation compensation value in the memory.

13. The information display apparatus of claim 10, wherein the light emitting display panel further includes a plurality of light detecting devices each of which is adjacently arranged to a corresponding light emitting diode, and
the information display apparatus further includes a light emitting adjustment calculation unit including a calibration value input unit configured to receive a light emitting calibration value and a modulation calibration value for calibrating the non-uniformity of the characteristics of the light emitting diodes during manufacturing from the outside and store the light emitting calibration value and the modulation calibration value in the memory and includes a degradation compensation calculation unit configured to calculate a light emitting compensation value for each light emitting diode and a modulation compensation value for each light modulating device on the basis of a brightness value measured through the light detecting devices in response to a check event for checking display quality during use and configured to store the calculated light emitting compensation value and the calculated modulation compensation value in the memory.

14. The information display apparatus of claim 1, further comprising a light diffusion plate arranged between the light emitting display panel and the light modulating panel.

15. A display control method of an information display apparatus including a light emitting display panel in which a plurality of light emitting diodes are arranged, and a light modulating panel which is located on a front surface of the light emitting display panel and in which a greater number of light modulating devices are arranged per unit area than a number of light emitting diodes per unit area of the light emitting display panel, the display control method comprising:
a display image generating operation of generating light emitting image data and display modulating data from an input image;
a light emitting image display control operation of generating a light emitting image driving signal by reflecting a light emitting adjustment value to the light emitting image data and outputting the light emitting image driving signal to the light emitting display panel; and
a modulation control operation of outputting a display modulation driving signal generated from the display modulating data to the light modulating panel.

16. The display control method of claim 15, wherein the display image generating operation includes:
is an operation of generating the light emitting image data by converting the input image to a low resolution image; and
an operation of generating the display modulating data by converting the input image into a monochrome image.

17. The display control method of claim 15, further comprising a calibration value input operation of storing a light emitting calibration value which is inputted from the outside in a memory.

18. The display control method of claim 15, further comprising a degradation compensation calculating operation of calculating a light emitting compensation value for each light emitting diode on the basis of a brightness value measured through light detecting devices each of which is adjacently arranged to a corresponding light emitting diode in response to a check event for checking display quality during use and storing the calculated light emitting compensation value in a memory.

19. The display control method of claim 17, further comprising a degradation compensation calculating operation of calculating a light emitting compensation value for each light emitting diode on the basis of a brightness value measured through light detecting devices each of which is adjacently arranged to a corresponding light emitting diode in response to a check event for checking display quality during use and storing a light emitting adjustment value which is obtained by adding the calculated light emitting compensation value to the light emitting calibration value in the memory.

20. The display control method of claim 15, wherein the modulation control operation includes:
a modulation image adjustment operation of generating display modulation driving data by reflecting a modulation adjustment value for compensating for non-uniformity of characteristics of the light emitting diodes in the display modulating data; and
a modulation driving operation of generating a display modulation driving signal from the generated display modulation driving data and outputting the display modulation driving signal to the light modulating panel.

21. The display control method of claim 20, further comprising a calibration value input operation of storing a light emitting calibration value and a modulation calibration value which are inputted from the outside in a memory.

22. The display control method of claim 21, further comprising a degradation compensation calculating operation of calculating a light emitting compensation value for each light emitting diode and a modulation compensation value for each light modulating device on the basis of a brightness value measured through light detecting devices each of which is adjacently arranged to correspond to the light emitting diodes in response to a check event for checking display quality during use and storing the calculated light emitting compensation value and the calculated modulation compensation value in the memory.

23. The display control method of claim 21, further comprising a degradation compensation calculating operation of calculating a light emitting compensation value for each light emitting diode and a modulation compensation value for each light modulating device on the basis of a brightness value measured through light detecting devices each of which is adjacently arranged to a corresponding light emitting diodes in response to a check event for checking display quality during use, calculating a light emitting adjustment value and a modulation adjustment value by adding the light emitting compensation value and the modulation compensation value to the light emitting calibration value and the modulation calibration value, respectively, and storing the calculated light emitting adjustment value and the calculated modulation adjustment value in the memory.
